(19) United States
(12) Patent Application Publication
(10) Pub. No.: US 2026/0154176 A1
(43) Pub. Date: Jun. 4, 2026

(54) SYSTEM AND METHOD FOR HANDLING OVER-THE-AIR EVENT LOGS

(71) Applicant: TOYOTA JIDOSHA KABUSHIKI KAISHA, Toyota-shi (JP)

(72) Inventor: Jonathan Alexander LISS, Tokyo (JP)

(73) Assignee: TOYOTA JIDOSHA KABUSHIKI KAISHA, Toyota-shi (JP)

(21) Appl. No.: 18/968,364

(22) Filed: Dec. 4, 2024

(51) Int. Cl. G06F 11/34; G06F 9/54

(52) U.S. Cl. CPC G06F 11/3476; G06F 9/542; G06F 2201/86

(57) ABSTRACT

Provided are a method, system, and device for handling event logs over the air. The method may include receiving, by a first handler object, a first log request to a first event log for a first event class, the first log request originating from a main logger object, wherein the first log request includes a first event object of the first event class and the first event log is stored in persistent storage and sending, by the handler object to a storage object, a first write request to write the first event object to the first event log, wherein upon receiving the first write request, the storage object is configured to serialize the first event object and write the serialized first event object to the first event log.

### TECHNICAL FIELD

Example embodiments of the present disclosure relate to over-the-air (OTA) transmissions and more particularly, event logging for OTA events.

### BACKGROUND

In the related art, events in relation to over-the-air (OTA) transmissions may be received. Such OTA events may be stored in a log for use in troubleshooting and compliance-related. Further, there may be different types of events such as communication log related, operation related, anomaly related, and events for debugging.

In the related art, it may not be clear as to how to handle different types of events for logging. In particular, different types of events may be handled using the same event log, even though the different types of events may have a different format.

Further, systems in the related art may typically use a single handler object occupying a single thread, which may not be efficient in terms of processing when multiple events may be concurrently received. Further still, there may be issues with handling storage for event logs, since allocated memory may be exceeded when logging.

Accordingly, a more efficient system is needed for handling different OTA event types for logging.

### SUMMARY

Example embodiments consistent with the present disclosure provide a process for more efficient handling of OTA event logs. In particular, apparatuses and methods according to example embodiments may include receiving, by a first handler object, a first log request to a first event log for a first event class, the first log request originating from a main logger object, wherein the first log request comprises a first event object of the first event class and the first event log is stored in persistent storage; sending, by the handler object to a storage object, a first write request to write the first event object to the first event log, wherein upon receiving the first write request, the storage object is configured to serialize the first event object and write the serialized first event object to the first event log.

According to embodiments, a method for handling event log entries may be provided. The method may include receiving, by a first handler object, a first log request to a first event log for a first event class, the first log request originating from a main logger object, wherein the first log request comprises a first event object of the first event class and the first event log is stored in persistent storage; and sending, by the handler object to a storage object, a first write request to write the first event object to the first event log, wherein upon receiving the first write request, the storage object is configured to serialize the first event object and write the serialized first event object to the first event log.

The method may include receiving, by a second handler object, a second log request to a second event log for a second event class different from the first event class, the second log request originating from the main logger object, wherein the second log request comprises a second event object of the second event class and the second event log is stored in the persistent storage; and sending, by the second handler object to the storage object, a second write request to write the second event object to the second event log, wherein upon receiving the second write request, the storage object is configured to serialize the second event object and write the serialized second event object to the second event log.

The storage object, upon receiving a begin read request originating from the main logger object, may be configured to reset a read pointer for the first event log. The storage object, upon receiving a read request originating from the main logger object, may also be configured to return an event object corresponding to the read pointer in the first event log to the main logger object in JSON format.

The first event log may be formatted as a first-in-first-out (FIFO) buffer, and wherein the storage object is configured to write the serialized first event object to the first event log by overwriting the earliest entry in the first event log if the first event log is full.

According to embodiments, the method may further include receiving, by the first handler object, a debug log request comprising a debug trace originating from the main logger object; and returning, by the first handler object, the debug trace to an output stream. The first handler object, the second handler object, and the storage object may be instantiated by the main logger object.

According to embodiments, an apparatus for handling event log entires may be provided. The apparatus may include at least one memory storing computer-executable instructions; and at least one processor configured to execute the computer-executable instructions to: receive, by a first handler object, a first log request to a first event log for a first event class, the first log request originating from a main logger object, wherein the first log request comprises a first event object of the first event class and the first event log is stored in persistent storage; and send, by the handler object to a storage object, a first write request to write the first event object to the first event log, wherein upon receiving the first write request, the storage object is configured to serialize the first event object and write the serialized first event object to the first event log.

According to embodiments, the processor may be further configured to execute the computer-executable instructions to: receive, by a second handler object, a second log request to a second event log for a second event class different from the first event class, the second log request originating from the main logger object, wherein the second log request comprises a second event object of the second event class and the second event log is stored in the persistent storage; and send, by the second handler object to the storage object, a second write request to write the second event object to the second event log, wherein upon receiving the second write request, the storage object is configured to serialize the second event object and write the serialized second event object to the second event log.

According to embodiments, the processor may be further configure to execute the computer-executable instructions to receive: by the first handler object, a debug log request comprising a debug trace originating from the main logger object; and returning, by the first handler object, the debug trace to an output stream.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of example components of a system for handling OTA event logging according to one or more example embodiments;

FIG. 2 illustrates an example call-flow diagram for initializing the system, according to one or more example embodiments;

FIG. 3 illustrates an example call-flow diagram for reading and writing an event, according to one or more example embodiments;

FIG. 4 illustrates an example method for implementing writing to multiple event logs, according to one or more example embodiments; and

FIG. 5 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide methods, systems, and devices for more efficient handling of OTA event logs. In particular, apparatuses and methods according to example embodiments may include receiving, by a first handler object, a first log request to a first event log for a first event class, the first log request originating from a main logger object, wherein the first log request comprises a first event object of the first event class and the first event log is stored in persistent storage; sending, by the handler object to a storage object, a first write request to write the first event object to the first event log, wherein upon receiving the first write request, the storage object is configured to serialize the first event object and write the serialized first event object to the first event log.

Ultimately, example embodiments of the present disclosure allow for more efficient handling of event logging. Since multiple handler objects may be used for each event type (which may correspond to different components in the OTA application), concurrent operation is permitted and multiple events may be received at the same time while avoiding any issues with threading. Likewise, since different event objects may be used for each event type, different event fields may be allowed for each different event type. Moreover, only a single main logger object is needed to act as a controller to handle multiple objects to reduce the amount of overall objects generated

In addition, since a FIFO queue using a circle buffer may be implemented, old logs may only be deleted for a given event type, without affecting logs from a different event type, while still only needing a single object for handling all of the persistent storage.

Accordingly, a more efficient method for handling multiple event types for OTA applications may be achieved.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

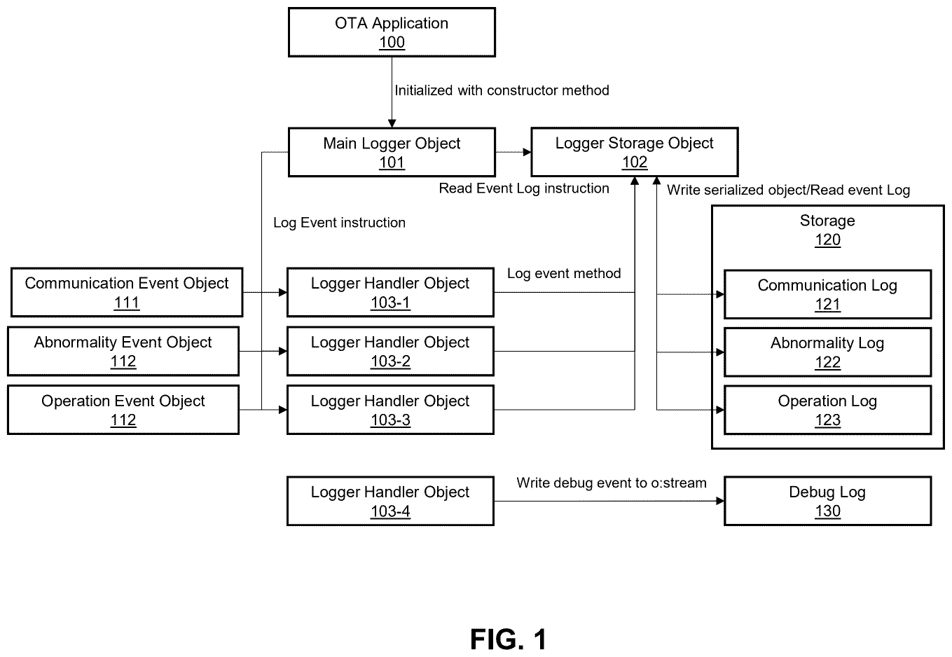

FIG. 1 illustrates a block diagram of example components of a system for handling OTA event logging according to one or more example embodiments.

According to embodiments, over-the-air (OTA) Application 100 may be provided. OTA Application 100 may be used to initialize the main logger object 101. Main logger object 101 may be responsible as the top-level class for logging in OTA application 100. Main logger object 101 may be the first object which is initialized by OTA application 100, and main logger object 101 may then be used to initialize multiple logger handler objects 103-1, 103-2, 103-3, 103-4 (which may be used by components of OTA application 100 to log events), and a single logger storage object 102 (which may perform storage handling tasks, and is shared with all objects). According to embodiments, main logger object 101 may also provide an interface for reading and clearing persistently stored logs. Main logger object 101 may allow for concurrent use (e.g., users of the same logger do not need to be concerned about using handles from different threads). In other words, multi-threading may be supported according to some implementations. According to embodiments, main logger object 101 may persist during the entirety of OTA Application 100's lifetime, and once main logger object 101 is deleted, all logger handler objects 103 and logger storage object 102 may no longer be valid.

Main logger object 101 may be initialized using a constructor method which may include a directory handle and application name as input.

Main logger object 101 may include a logger handler pointer method to return a pointer to a logger handler object 103 for a specific component. The input for the logger handler pointer method may be based on a string name indicating the component name associated with the logger handler object.

Moreover, main logger object 101 may include a method for starting reading of an event log, which may reset the pointer (e.g., a tail pointer) for reading to the beginning of the particular event log (e.g., one of communication log 121, abnormality log 122, or operation log 123). In some implementations, this method may be required prior to allowing main logger object 101 to read an entry from the particular event log. Each type of event log may have its own unique method for the above operation, according to embodiments.

Main logger object 101 may include a method for performing the reading of the event log. This method may read the entry corresponding to the pointer, and return the log entry in a serialized format (e.g., JSON format). If there are no more entries a null pointer or a zero length string may be returned. The pointer may then be advanced to the next entry if the read method is performed again. Each type of event log may have its own unique method for the above operation, according to embodiments.

Main logger object 101 may include a method for deleting the entire event log corresponding to a particular event type. Each type of event log may have its own unique method, according to embodiments.

According to embodiments, a logger handler object 103 may be provided. As explained above, the logger handler class object may be initialized by the main logger object. Each logger handler object (each of 103-1, 103-2, 103-3, 103-4) may be used to handle logging for each component of the OTA application by communicating with the object responsible for handling persistent storage (e.g., logger storage object 102), and accordingly, each logger handler object 103-1, 103-2, 103-3, 103-4 may be responsible for a single event type (e.g., communication, abnormality, operation, and debug), although it should be appreciated that in some configurations, the logger handler object 103 may handle more than one single event type, depending on the implementation.

Each logged event may be defined as an event object, such as communication event object 111, abnormality event object 112, operation event object 113. Each event object may be internally associated with a timestamp when being stored. According to embodiments, each logged event may also generate a debug trace string (to be associated with the debug log 130).

The logger handler object 103 may be initialized using a constructor method including the component name in the OTA application 100, the OTA application name, and a reference to logger storage object 102. This constructor method may typically be used by the main logger object 101.

According to embodiments, a log event method may be provided for the logger handler object 103. The log event method may receive the event in the form of an event object (111, 112, 113) as an input parameter. Each type of event log may have its own unique method, and unique event object class, according to embodiments (e.g., an abnormality log event method for abnormality log 122 may require an abnormality event object 112 as an input, whereas a communication log event method for communication log 121 may require a communication event object 111 as an input, the abnormality event object 112 and communication event object 111 being separate classes). The particular operation for each log event method for each event object class may be different from each other, according to the specific implementation.

Each type of event log may generate a debug print of the event, although for some event types, (such as for communication events), this may be disabled due to flooding the output stream.

According to embodiments, a debug method may be included. This may be used for the debug log 130, and may print a debug message to an output stream based on the debug trace.

As mentioned above, logger storage object 102 may be provided. The logger storage object 102 may be used to coordinate storing (writing) events in event logs in storage 120, and to allow the main logger object 101 to read back the logs. According to embodiments, logger storage object 102 may be used to serialize (e.g., convert from an event object to a format such as JSON string) and de-serialize logged events. Interaction with storage 120 may be handled using an API (e.g., PAL). A single logger storage object 102 may be initiated and allocated by the main logger object 101, and shared to the logger handler objects 103 (e.g., by reference). According to embodiments, multiple logger handler objects 103 may send log events to be written to the event log at any time (concurrently), such that the operations from each logger handler object to the logger storage object be thread safe.

Each event log (121, 122, 123), which may each correspond to a different event type, may be in a FIFO ring buffer configuration (as explained above). The logger storage object may keep track of the head and tail pointers (which may be stored in the first few bytes of the storage log file). The oldest entry may be overwritten when the capacity is full (e.g., when the head pointer overtakes the tail pointer). Each event log may have a specific storage allocation (e.g., 10 MB). Each event log (121, 122, 123) may be binary packed and stored as a discrete item in the ring buffer, such that each event entry is logged as a plurality of integer values with fixed size. It should be appreciated that the file corresponding to each event log/event type may need to be opened in binary, such that the bytes can be overwritten.

Logger storage object 102 may have a constructor method, which may be executed by the main logger object 101 to initialize the logger storage object 102.

According to embodiments, a write log entry method may be provided. The method may include the timestamp and a serialized event log entry (e.g., the event object converted into a serialized format such as JSON) may be provided. Each type of event log may have its own unique method, according to embodiments.

Logger Storage Object 102 handles the method for starting reading of a event log (as mentioned above with reference to the main logger object), which may reset the pointer (e.g., a tail pointer) for reading to the beginning of the particular event log. In some implementations, this method may be required prior to allowing the main logger object 101 to read an entry from the particular event log. Each type of event log may have its own unique method for the above operation, according to embodiments.

Logger Storage Object 102 may handle the method for reading an entry in the event log (as mentioned above with reference to the main logger object 101), This method may read the entry corresponding to the pointer, and return the log entry in a serialized format (e.g., JSON format). If there are no more entries a null pointer or a zero length string may be returned. The pointer may then be advanced to the next entry if the read method is performed again. Each type of event log may have its own unique method for the above operation, according to embodiments.

The logger storage object 102 may be able to handle deleting an event log, according to embodiments.

According to embodiments, different types of events may need to be handled by the system. Each type of event may be stored in separate event logs. Each event log may be separately stored in storage 120, which may be persistent storage. According to embodiments, the event logs may be stored using a first-in-first-out (FIFO) queue. According to embodiments, the FIFO queue may be implemented using a ring buffer, with tail/head pointers.

According to embodiments, a communication log 121 may be provided. Communication log 121 may be responsible for keeping track of all communication events during, for example, an OTA update campaign. This may include transmission and receiving events. Communication events may be required to be logged in order to troubleshoot any issues which occur (e.g., following a failed update).

According to embodiments, abnormality log 122 may be provided. The abnormality log may contain information about abnormalities (e.g., abnormality events) which happen, for example, a transmission error during an OTA update. According to embodiments, this may include an error code.

According to embodiments, operation log 123 may be provided. The operation log may include user events and campaign state events which occur, for example, during an OTA update campaign.

According to embodiments, a debug log 130 may be provided. The debug log may not necessarily be stored in storage 120, and may only be used to provide as an API for debug trace logging during development. The debug log may be outputted as an output stream (o: stream) in order to capture information while running integration tests.

Each of the event logs may correspond to unique event object classes, and each event object may have its own unique set of fields, e.g., communication event object 111, abnormality event object 112, and operation event object 112. For example, communication log event 111 may have a field indicating direction of communication event, whereas abnormality event 112 may have a field indicating error code.

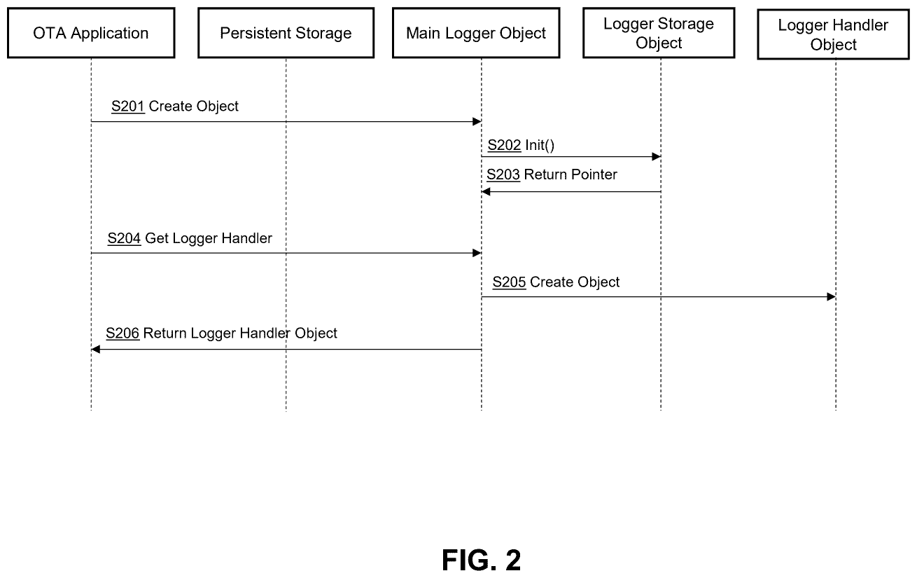

FIG. 2 illustrates an example call-flow diagram for initializing the system, according to one or more example embodiments. OTA application, persistent storage (e.g., storage 120), main logger object, logger storage object, and logger handler object may be provided, and may correspond to their counterparts as described with reference to FIG. 1 above.

At operation S201, the OTA application may create the main logger object. This may be performed after persistent storage is initialized, so that all components may be able to access the main logger object and each can instantiate their own logger handler objects.

At operation S202, the main logger object may initialize the logger storage object (e.g., using a constructor method).

At operation S203, the logger storage object may return a message or pointer to the main logger object indicating that the logger storage object was successfully initialized.

At operation S204, a get logger handler operation may be performed by the OTA application.

At operation S205, based on operation S204, main logger object may create the logger handler object. As described above, each logger handler object may correspond to a particular component and/or event type for the given OTA application.

At operation S206, main logger object may return the reference pointer to the created logger handler object, to the OTA application.

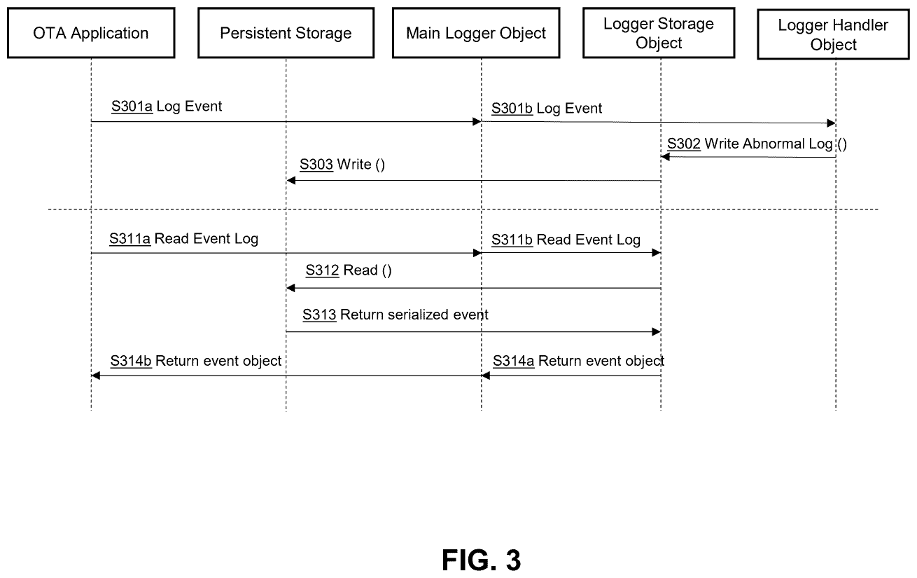

FIG. 3 illustrates an example call-flow diagram for reading and writing an event, according to one or more example embodiments. OTA application, persistent storage (e.g., storage 120), main logger object, logger storage object, and logger handler object may be provided, and may correspond to their counterparts as described with reference to FIG. 1 above. Steps illustrated in FIG. 3 may be executed, for example, following the steps illustrated in FIG. 2.

Operations S301-S303 illustrate an example write operation. S301-S303 may be repeated for multiple logger handler objects for different event logs, depending on the implementation.

At operation S301a, a log event operation may be sent by the OTA application. According to embodiments, this may first be sent to the main logger object then forwarded to logger handler object in operation S301b, or may be sent from OTA application to logger handler object directly.

At operation S302, a write abnormal log (e.g., write request) may be sent by the logger handler object to the logger storage object. Upon receiving the write request, logger storage object may serialize the object into a string (such as JSON format).

At operation S303, logger storage object may write the serialized event object to the event log in the persistent storage. It should be appreciated that in this step, logger storage object may overwrite the earliest entry if storage is full for a given event log.

Operations S311-S314 illustrate an example read operation.

At operation S311a, a read event log operation may be sent by the OTA application. According to embodiments, this may first be sent to the main logger object then forwarded to logger storage object in operation S311b, or may be sent from OTA application to logger storage object directly.

At operation S312, a read log request may be sent to persistent storage.

At operation S313, based on the request from S312, a serialized event may be returned to logger storage object. Logger storage object may de-serialize the event back into an event object.

At operation S314a, logger storage object may return the event object to OTA application. According to embodiments, this may first be sent from logger storage object to main logger object and forwarded to OTA application in operation S314b, or may be sent from logger storage object to OTA application directly.

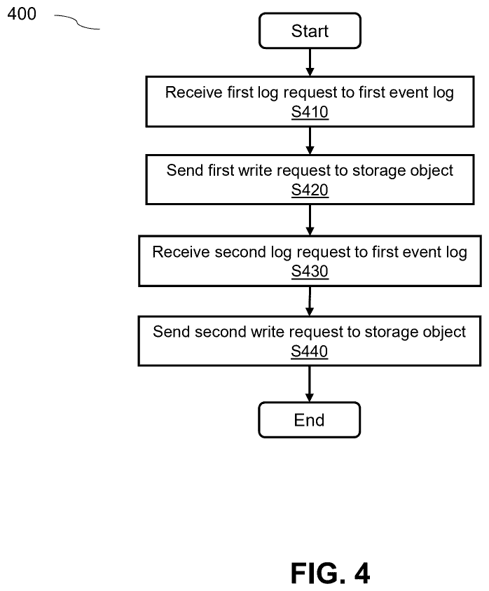

FIG. 4 illustrates an example method 400 for implementing writing to multiple event logs, according to one or more example embodiments.

At operation S410, a first log request to a first event log is received by a first handler object. The first log request may be of a first event class, and may originate from a main logger object. The first log request may include a first event object of the first event class, and the first event log may be stored in persistent storage.

At operation S420, a first write request may be sent to the storage object by the handler object. The first write request may indicate to write the first event object to the first event log. Upon receiving the first write request, the storage object may be configured to serialize the first event object and write the serialized first event object to the first event log.

At operation S430, a second log request to a second event log is received. The second log request may be of a second event class different from the first event class, and may originate from a main logger object. The second log request may include a second event object of the second event class, and the second event log may be stored in persistent storage.

At operation S440, a second write request may be sent to the storage object by the handler object. The second write request may indicate to write the second event object to the second event log. Upon receiving the second write request, the storage object may be configured to serialize the second event object and write the serialized second event object to the second event log.

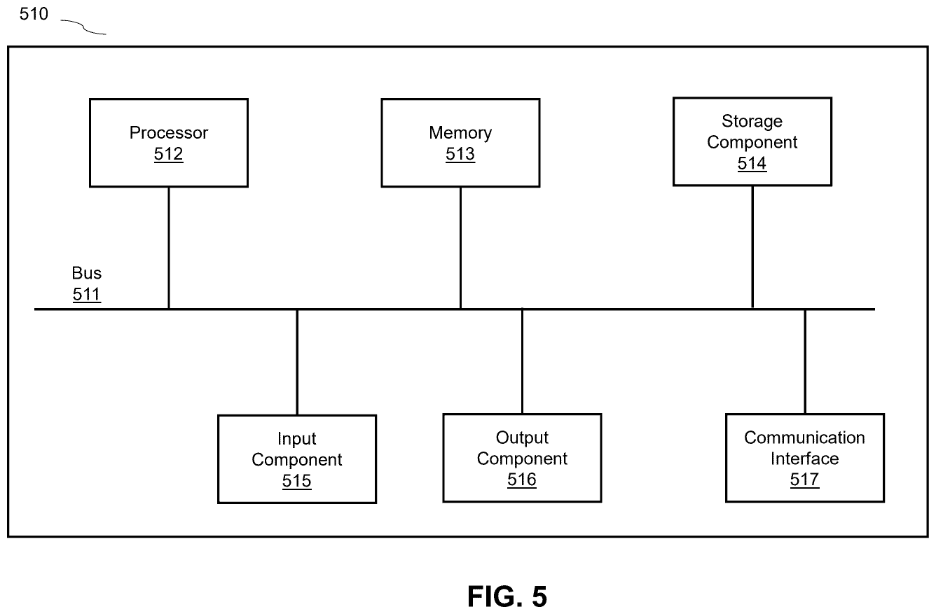

FIG. 5 illustrates a diagram of example components of a system, according to one or more example embodiments. As illustrated in FIG. 5, the system 510 may include at least one bus 511, at least one processor 512, at least one memory 513, at least one storage component 514, at least one input component 516, at least one output component 516, and at least one communication interface 517.

It is contemplated that the system 510 may include more or less components than illustrated in FIG. 5, without departing from the scope of the present disclosure. For instance, in some embodiments, the system 510 may include a plurality of storage components 514, the input component 515 and the output component 516 may be implemented as a transceiver component, the memory 513 and storage component 514 may be implemented as a memory storage, and the like.

The bus 511 may be configured to facilitate or enable communications among the components of the system 510. Specifically, the bus 511 may communicatively couple the components to each other and provide a means for data transfer and flow of control signals between the components. The bus 511 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 510 to enable communication and coordination between the components within the system 510 in real-time (or near real-time).

The processor 512 may be implemented in hardware, firmware, or a combination of hardware and software, and may be configured to handle real-time (or near real-time) data processing and control of the control system 510. The processor 512 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 510. In some implementations, the processor 512 may be capable of being programmed to perform one or more operations described herein. Further, the processor 512 may include a plurality of processing units, each of which is dedicated to performing a specific operation.

The memory 513 may include one or more mediums for storing temporary data, runtime variables, program instructions, and buffers required for the operations of the control system 510. The memory 513 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 510 to store information and/or instructions for use by the processor 512.

The storage component 514 may be configured to store non-volatile data, such as firmware, configuration settings, calibration data, information, and/or software related to the operation and use of the system 510. For example, the storage component 514 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 514 may be configured to store computer-readable or computer-executable instructions for implementing one or more operations of the system 510. The storage component 514 may provide the stored information to the memory 513 for the execution of the processor 512.

The input component 515 may include one or more input components that permit the system 510 to receive information, such as via user input (e.g., a touch screen display, a keyboard, a keypad, a mouse, a button, a switch, and/or a microphone). The output component 516 may include one or more output components that provide output information from the system 510 (e.g., a display, a speaker, a navigation device, one or more light-emitting diodes (LEDs), etc.) According to embodiments, the input component 515 and/or the output component 516 may be optional and may be excluded from the system 510.

The at least one communication interface 517 may include a transceiver-like component (e.g., a transceiver and/or a separate receiver and transmitter) that enables the system 510 to communicate with other components (e.g., ECUs, user devices, etc.), such as via a wired connection, a wireless connection, or a combination of wired and wireless connections. For example, communication interface 517 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 517 may include at least one input/output (I/O) interface, at least one network interface, at least one storage interface, or the like, that enable the components 512-516 to communicate with other components. Further, the communication interface 517 may include one or more application programming interfaces (APIs) that allow the system 510 (or one or more components included therein) to communicate with one or more software applications (e.g., software application deployed in the ECUs, etc.)

Computer-executable instructions (e.g., software instructions, etc.) may be read into memory 513 and/or storage component 514 from another computer-readable medium or from another device (e.g., a remote server, an external storage, etc.) via, for example, the communication interface 517. When executed, the computer-executable instructions stored in memory 513 and/or storage component 514 may cause the processor 512 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Based on the above, it can be understood that example embodiments of the present disclosure allow for more efficient handling of event logging. Since multiple handler objects may be used for each event type (which may correspond to different components in the OTA application), concurrent operation is permitted and multiple events may be received at the same time while avoiding any issues with threading. Likewise, since different event objects may be used for each event type, different event fields may be allowed for each different event type. Moreover, only a single main logger object is needed to act as a controller to handle multiple objects to reduce the amount of overall objects generated

In addition, since a FIFO queue using a circle buffer may be implemented, old logs may only be deleted for a given event type, without affecting logs from a different event type, while still only needing a single object for handling all of the persistent storage.

Accordingly, a more efficient method for handling multiple event types for OTA applications may be achieved.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for handling event log entries, the method comprising:
receiving, by a first handler object, a first log request to a first event log for a first event class, the first log request originating from a main logger object, wherein the first log request comprises a first event object of the first event class and the first event log is stored in persistent storage; and
sending, by the handler object to a storage object, a first write request to write the first event object to the first event log, wherein upon receiving the first write request, the storage object is configured to serialize the first event object and write the serialized first event object to the first event log.

2. The method as claimed in claim 1, further comprising:
receiving, by a second handler object, a second log request to a second event log for a second event class different from the first event class, the second log request originating from the main logger object, wherein the second log request comprises a second event object of the second event class and the second event log is stored in the persistent storage; and
sending, by the second handler object to the storage object, a second write request to write the second event object to the second event log, wherein upon receiving the second write request, the storage object is configured to serialize the second event object and write the serialized second event object to the second event log.

3. The method as claimed in claim 1, wherein the storage object, upon receiving a begin read request originating from the main logger object, is configured to reset a read pointer for the first event log.

4. The method as claimed in claim 3, wherein the storage object, upon receiving a read request originating from the main logger object, is configured to return an event object corresponding to the read pointer in the first event log to the main logger object in JSON format.

5. The method as claimed in claim 1, wherein the first event log is formatted as a first-in-first-out (FIFO) buffer, and wherein the storage object is configured to write the serialized first event object to the first event log by overwriting the earliest entry in the first event log if the first event log is full.

6. The method as claimed in claim 1, further comprising
receiving, by the first handler object, a debug log request comprising a debug trace originating from the main logger object; and
returning, by the first handler object, the debug trace to an output stream.

7. The method as claimed in claim 2, wherein the first handler object, the second handler object, and the storage object are instantiated by the main logger object.

8. An apparatus for handling event log entries, the apparatus comprising:
at least one memory storing computer-executable instructions; and
at least one processor configured to execute the computer-executable instructions to:
receive, by a first handler object, a first log request to a first event log for a first event class, the first log request originating from a main logger object, wherein the first log request comprises a first event object of the first event class and the first event log is stored in persistent storage; and
send, by the handler object to a storage object, a first write request to write the first event object to the first event log, wherein upon receiving the first write request, the storage object is configured to serialize the first event object and write the serialized first event object to the first event log.

9. The apparatus as claimed in claim 8, wherein the at least one processor is further configured to execute the computer-executable instructions to:
receive, by a second handler object, a second log request to a second event log for a second event class different from the first event class, the second log request originating from the main logger object, wherein the second log request comprises a second event object of the second event class and the second event log is stored in the persistent storage; and
send, by the second handler object to the storage object, a second write request to write the second event object to the second event log, wherein upon receiving the second write request, the storage object is configured to serialize the second event object and write the serialized second event object to the second event log.

10. The apparatus as claimed in claim 8, wherein the storage object, upon receiving a begin read request originating from the main logger object, is configured to reset a read pointer for the first event log.

11. The apparatus as claimed in claim 10, wherein the storage object, upon receiving a read request originating from the main logger object, is configured to return an event object corresponding to the read pointer in the first event log to the main logger object in JSON format.

12. The apparatus as claimed in claim 8, wherein the first event log is formatted as a first-in-first-out (FIFO) buffer, and wherein the storage object is configured to write the serialized first event object to the first event log by overwriting the earliest entry in the first event log if the first event log is full.

13. The apparatus as claimed in claim 8, wherein the at least one processor is further configured to execute the computer-executable instructions to:
receive, by the first handler object, a debug log request comprising a debug trace originating from the main logger object; and
return, by the first handler object, the debug trace to an output stream.

14. The method as claimed in claim 9, wherein the first handler object, the second handler object, and the storage object are instantiated by the main logger object.

15. A non-transitory computer-readable recording medium having recorded thereon instructions executable by at least one processor to cause the at least one processor to perform a method for outputting a user interface for setting an operational rule for controlling one or more components of a vehicle, the method comprising:
receiving, by a first handler object, a first log request to a first event log for a first event class, the first log request originating from a main logger object, wherein the first log request comprises a first event object of the first event class and the first event log is stored in persistent storage; and
sending, by the handler object to a storage object, a first write request to write the first event object to the first event log, wherein upon receiving the first write request, the storage object is configured to serialize the first event object and write the serialized first event object to the first event log.

16. The non-transitory computer-readable recording medium as claimed in claim 15, the method further comprising:
receiving, by a second handler object, a second log request to a second event log for a second event class different from the first event class, the second log request originating from the main logger object, wherein the second log request comprises a second event object of the second event class and the second event log is stored in the persistent storage; and
sending, by the second handler object to the storage object, a second write request to write the second event object to the second event log, wherein upon receiving the second write request, the storage object is configured to serialize the second event object and write the serialized second event object to the second event log.

17. The non-transitory computer-readable recording medium as claimed in claim 15, wherein the storage object, upon receiving a begin read request originating from the main logger object, is configured to reset a read pointer for the first event log.

18. The non-transitory computer-readable recording medium as claimed in claim 17, wherein the storage object, upon receiving a read request originating from the main logger object, is configured to return an event object corresponding to the read pointer in the first event log to the main logger object in JSON format.

19. The non-transitory computer-readable recording medium as claimed in claim 15, wherein the first event log is formatted as a first-in-first-out (FIFO) buffer, and wherein the storage object is configured to write the serialized first event object to the first event log by overwriting the earliest entry in the first event log if the first event log is full.

20. The non-transitory computer-readable recording medium as claimed in claim 15, the method further comprising
receiving, by the first handler object, a debug log request comprising a debug trace originating from the main logger object; and
returning, by the first handler object, the debug trace to an output stream.
